(19) United States
(12) Patent Application Publication
(10) Pub. No.: US 2023/0308539 A1
(43) Pub. Date: Sep. 28, 2023

(54) INFORMATION PROCESSING APPARATUS, INFORMATION PROCESSING METHOD, AND PROGRAM

(71) Applicant: NEC Corporation, Tokyo (JP)

(72) Inventors: Satoshi Hiratsuka, Tokyo (JP); Takeshi Mori, Kanagawa (JP)

(73) Assignee: NEC Corporation, Tokyo (JP)

(21) Appl. No.: 18/119,191

(22) Filed: Mar. 8, 2023

(30) Foreign Application Priority Data
Mar. 28, 2022 (JP) 2022-052141

(51) Int. Cl. H04M 3/00; H04L 47/283; H04L 65/80

(52) U.S. Cl. CPC H04M 3/002; H04L 47/283; H04L 65/80

(57) ABSTRACT

A processing load at calling is reduced. An information processing apparatus including: a management unit configured to manage a control parameter related to call quality of a call previously made with a user terminal; and a transmission unit configured to relay packets of call voice and transmit the packets to an edge apparatus when a call is made with the user terminal, the edge apparatus being configured to perform processing based on the control parameter is provided.

### INCORPORATION BY REFERENCE

This application is based upon and claims the benefit of priority from Japanese patent application No. 2022-052141, filed on Mar. 28, 2022, the disclosure of which is incorporated herein in its entirety by reference.

### TECHNICAL FIELD

The present disclosure relates to an information processing apparatus, an information processing method, a program, and a call system.

### BACKGROUND ART

In a known technology (refer to Japanese Unexamined Patent Application Publication No. 2006-148330, for example), an edge apparatus that relays packets of call voice performs processing related to call quality. Japanese Unexamined Patent Application Publication No. 2006-148330 discloses a technology that, in a line switching system, an adaptive filter is trained with a trunk including a two-wire/four-wire conversion circuit (hybrid circuit) so that echo is reduced.

### SUMMARY

However, in the technology disclosed in Japanese Unexamined Patent Application Publication No. 2006-148330, the training is performed at each call, which leads to a problem with the occurrence of electric power consumption or a processing load for the training.

An example object of the present disclosure is to provide a technology with which a processing load at calling can be reduced.

In a first example aspect according to the present disclosure, an information processing apparatus includes: a management unit configured to manage a control parameter related to call quality of a call previously made with a user terminal; and a transmission unit configured to relay packets of call voice and transmit the packets to an edge apparatus when a call is made with the user terminal, the edge apparatus being configured to perform processing based on the control parameter.

In a second example aspect according to the present disclosure, an information processing method includes: managing a control parameter related to call quality of a call previously made with a user terminal; and relaying packets of call voice and transmitting the packets to an edge apparatus when a call is made with the user terminal, the edge apparatus being configured to perform processing based on the control parameter.

In a third example aspect according to the present disclosure, a program causes a computer to execute processing including: managing a control parameter related to call quality of a call previously made with a user terminal; and relaying packets of call voice and transmitting the packets to an edge apparatus when a call is made with the user terminal, the edge apparatus being configured to perform processing based on the control parameter.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating an example of the configuration of an information processing apparatus according to an example embodiment;

FIG. 2 is a diagram illustrating an example of the configuration of an information processing system according to the example embodiment;

FIG. 3 is a diagram illustrating an example of a hardware configuration of the information processing apparatus and an edge apparatus according to the example embodiment;

FIG. 4 is a sequence diagram illustrating an example of processing of managing a control parameter in a call system 1 according to the example embodiment;

FIG. 5 is a diagram illustrating an example of information stored in a control parameter DB according to the example embodiment; and

FIG. 6 is a sequence diagram illustrating an example of processing of using a control parameter in the call system according to the example embodiment.

### EXAMPLE EMBODIMENT

The principle of the present disclosure will be described with reference to example embodiments. It should be understood that the example embodiments are merely exemplary and do not indicate any restriction related to the scope of the present disclosure but allow the skilled person in the art to understood and perform the present disclosure. The disclosure described in the present specification is implemented by various methods other than those described below.

In the following description and the claims, unless otherwise defined, all technological and scientific terms used in the present specification have the same meanings as typically understood by the skilled person in the art in a technical field to which the present disclosure belongs.

Example embodiments of the present disclosure will be described below with reference to the accompanying drawings.

### First Example Embodiment

Configuration

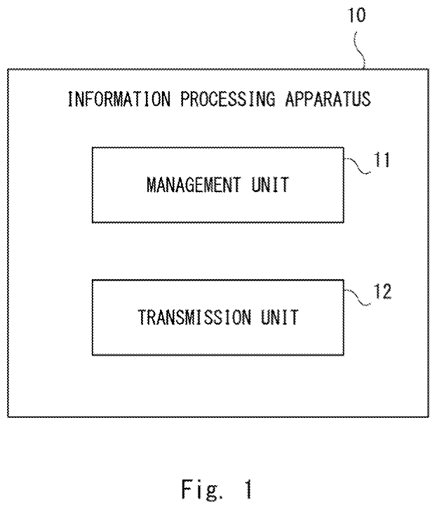

The configuration of an information processing apparatus 10 according to the example embodiment will be described below with reference to FIG. 1. FIG. 1 is a diagram illustrating an example of the configuration of the information processing apparatus 10 according to the example embodiment. The information processing apparatus 10 includes a management unit 11 and a transmission unit 12. These components may be implemented by cooperation of one or more programs installed on the information processing apparatus 10 and of hardware components such as a processor 101 and a memory 102 of the information processing apparatus 10.

The management unit 11 manages a control parameter related to call quality of a call previously made with a user terminal 30. The transmission unit 12 relays packets of call voice and transmits the packets to an edge apparatus 20 when a call is made with the user terminal 30, the edge apparatus 20 being configured to perform processing based on the control parameter.

### Second Example Embodiment

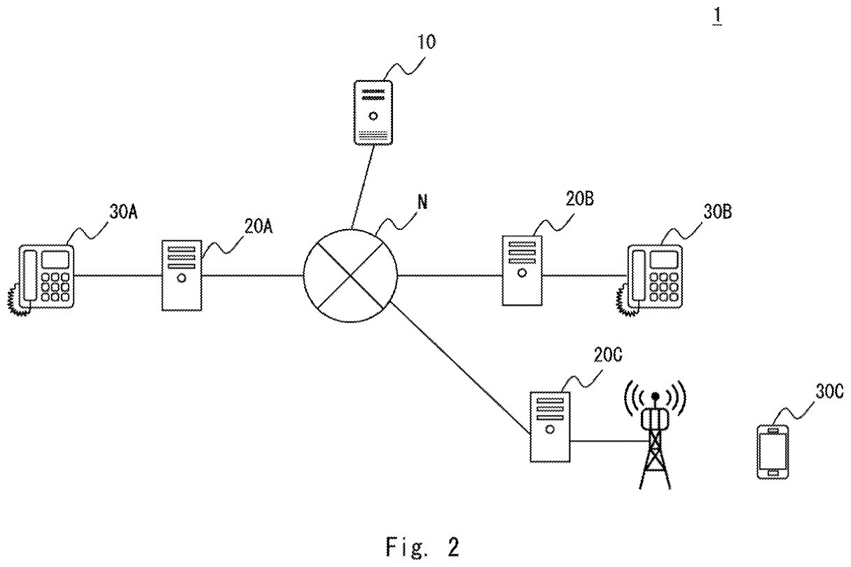

The configuration of a call system 1 according to the example embodiment will be described next with reference to FIG. 2.

System Configuration

FIG. 2 is a diagram illustrating an example of the configuration of the call system 1 according to the example embodiment. In the example illustrated in FIG. 2, the call system 1 includes the information processing apparatus 10. The call system 1 also includes an edge apparatus 20A, an edge apparatus 20B, and an edge apparatus 20C (hereinafter simply referred to as the “edge apparatuses 20” when not needing to be distinguished from one another). The call system 1 also includes a user terminal 30A, a user terminal 30B, and a user terminal 30C (hereinafter simply referred to as the “user terminals 30” when not needing to be distinguished from one another).

In the example illustrated in FIG. 2, the information processing apparatuses 10 and the edge apparatuses 20 are connected to be able to communicate with one another through a network N. The edge apparatus 20A, the edge apparatus 20B, and the edge apparatus 20C are connected to be able to communicate with the user terminal 30A, the user terminal 30B, and the user terminal 30C, respectively, through a communication line. The number of information processing apparatuses 10, the number of edge apparatuses 20, and the number of user terminals 30 are not limited to those in the example illustrated in FIG. 2.

Examples of the network N may include a core network and the Internet. Examples of communication lines A to C may include an optical fiber cable, an electric signal cable, and wireless communication. Examples of the wireless communication may include a fifth generation mobile communication system (5G), a sixth generation mobile communication system (6G, Beyond 5G), a fourth generation mobile communication system (4G), a third generation mobile communication system (3G), and a wireless local area network (LAN).

The information processing apparatus 10 may be, for example, a server connected to a core network, or an apparatus such as a cloud. The information processing apparatus 10 may be, for example, a call control server configured to manage a call session between user terminals 30.

Each user terminal 30 may be, for example, a land-line phone or a mobile terminal. Examples of the land-line phone may include an analog phone and an internet protocol (IP) phone. Examples of the mobile terminal may include a smartphone and a cellular phone.

Each edge apparatus 20 may be, for example, an apparatus installed in a switching station (housing station) housing a user terminal 30 that is a land-line phone. Alternatively, the edge apparatus 20 may be, for example, an apparatus connected to a base station housing a user terminal 30 that is a mobile terminal. In this case, the edge apparatus 20 may be, for example, a multi-access edge computing (MEC) server. For example, the edge apparatus 20 may relay voice packets in a call session between user terminals 30.

### Hardware Configuration

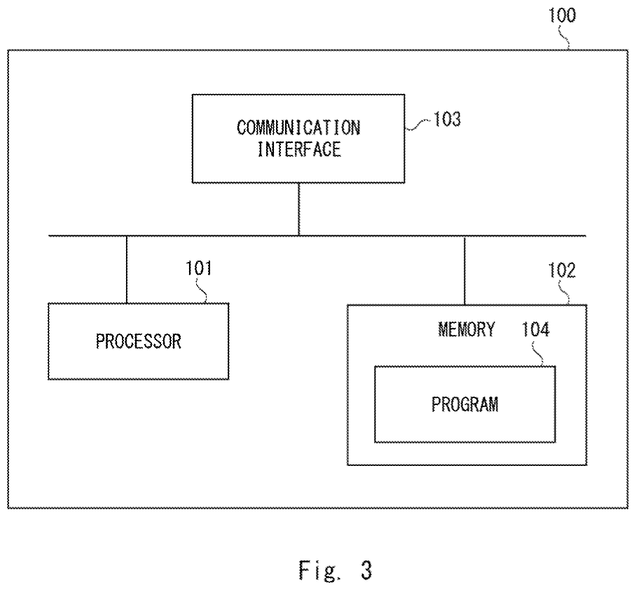

FIG. 3 is a diagram illustrating an example of a hardware configuration of the information processing apparatus 10 and each edge apparatus 20 according to the example embodiment. The following description will be made with the information processing apparatus 10 as an example. The hardware configuration of the edge apparatus 20 may be the same as the hardware configuration of the information processing apparatus 10.

In the example illustrated in FIG. 3, the information processing apparatus 10 (computer 100) includes the processor 101, the memory 102, and a communication interface 103. These components may be connected to each other through a bus or the like. The memory 102 stores at least part of a program 104. The communication interface 103 includes an interface that is necessary for communication with another network element.

When the program 104 is executed by cooperation of the processor 101, the memory 102, and the like, at least part of processing in the example embodiment of the present disclosure is performed by the computer 100. The memory 102 may be of an optional type that is suitable for a local technological network. The memory 102 may be a non-transitory computer-readable storage medium as a non-limiting example. Alternatively, the memory 102 may be implemented by using an optional appropriate data storage technology such as a semiconductor-based memory device, a magnetic memory device or system, an optical memory device or system, or a fixed memory or removable memory. Only one memory 102 is illustrated in the computer 100, but physically different memory modules may exist in the computer 100. The processor 101 may be of an optional type. The processor 101 may include one or more of a general-purpose computer, a dedicated computer, a microprocessor, a digital signal processor (DSP), and a processor based on multi-core processor architecture as a non-limiting example. The computer 100 may include a plurality of processors such as application specific integrated circuit chips that temporally follow a clock that synchronizes main processors.

The example embodiment of the present disclosure may be implemented by a hardware component or a dedicated circuit, a software component, a logic, or optional combination thereof. Some example aspects may be implemented by hardware components and the other example aspects may be implemented by firmware or software components that can be executed by a controller, a microprocessor, or another computing device.

The present disclosure also provides at least one computer program product physically stored in a non-transitory computer-readable storage medium. The computer program product includes a computer-executable command such as a command included in a program module, is executed by a device on a target real processor or virtual processor, and executes a process or method of the present disclosure. Each program module includes a routine, a program, a library, an object, a class, a component, a data structure, or the like that, for example, executes a particular task and implements a particular abstract data type. Functions of the program modules may be integrated or divided between program modules as desired in various example embodiments. A machine executable command of each program module may be executed in a local or distributed device. In the distributed device, the program module may be allocated in both local and remote storage medium.

Program codes for executing the method of the present disclosure may be written in optional combination of one or more programming languages. These program codes are provided to a processor or controller of a general-purpose computer, a dedicated computer, or another programmable data processing apparatus. When the program codes are executed by the processor or the controller, functions and operation in a flowchart and/or block diagram to be implemented are executed. All program codes are executed on a machine, some program codes are executed as a stand-alone software package on the machine, some program codes are executed on the machine whereas the other program codes are executed on a remote machine, or all program codes are executed on a remote machine or a server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### Processing

### Processing of Managing Control Parameter

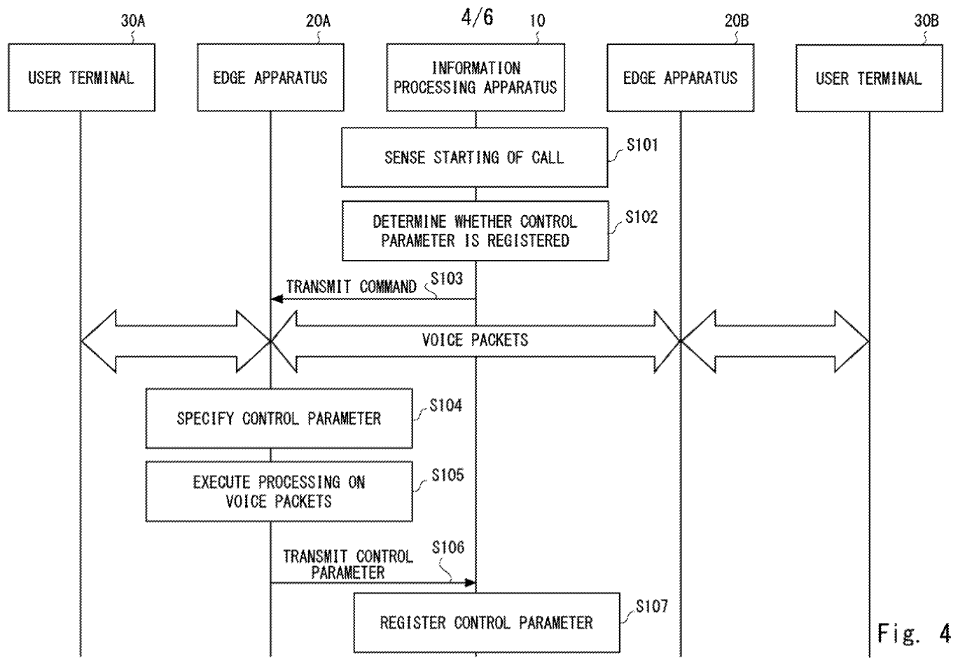

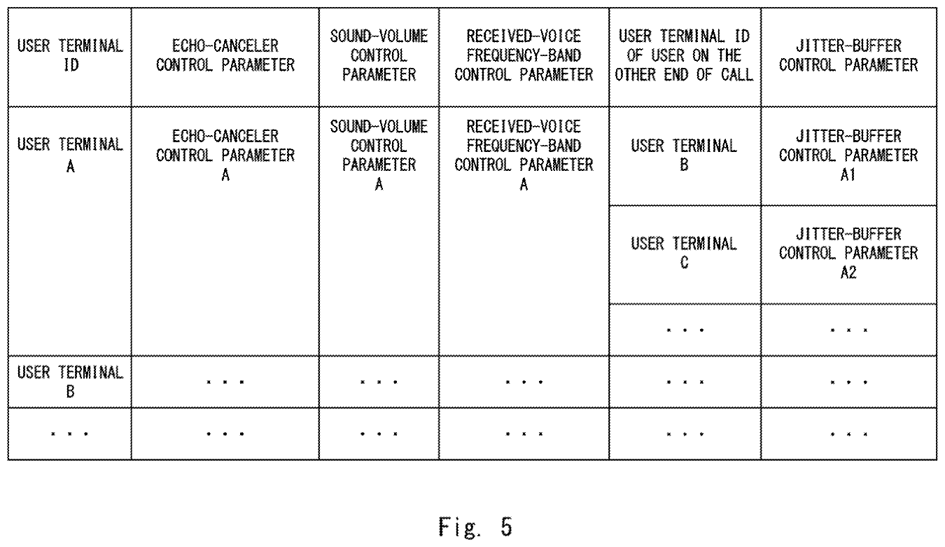

An example of processing of managing a control parameter in the call system 1 according to the example embodiment will be described next with reference to FIGS. 4 and 5. FIG. 4 is a sequence diagram illustrating the example of processing of managing a control parameter in the call system 1 according to the example embodiment. FIG. 5 is a diagram illustrating an example of information stored in a control parameter database (DB) 501 according to the example embodiment.

The following description will be made with an example in which processing related to call quality is performed by the edge apparatus 20A when a call is made between the user terminal 30A and the user terminal 30B. The description is the same irrespective of whether a call request (outgoing call) is made by the user terminal 30A or the user terminal 30B, but the description will be made with a case where call request is made by the user terminal 30A. In a case where a call request is made by the user terminal 30B and received by the user terminal 30A, for example, call request and outgoing in the following description may be interpreted as call reception and incoming, respectively.

At step S101, the management unit 11 of the information processing apparatus 10 senses starting of a call between the user terminal 30A and the user terminal 30B. The information processing apparatus 10 may receive a connection request from the user terminal 30A at the calling source through the edge apparatus 20A at the calling source and may forward the connection request to the user terminal 30B at the call destination through the edge apparatus 20B at the call destination. The connection request may include, for example, the ID of the call session, the user terminal ID of the calling source, and the user terminal ID of the call destination.

Subsequently, the management unit 11 of the information processing apparatus 10 determines whether any control parameter for the user terminal 30A is recorded (registered) in the control parameter DB 501 (step S102). The control parameter DB 501 may be recorded in a storage apparatus inside the information processing apparatus 10 or may be recorded in a storage apparatus outside the information processing apparatus 10. In the example illustrated in FIG. 5, an echo-canceler control parameter, a sound-volume control parameter, and a received-voice frequency-band control parameter are recorded in the control parameter DB 501 in association with a user terminal ID. In addition, a jitter-buffer control parameter is recorded in the control parameter DB 501 in association with combination of a user terminal ID and a user terminal ID on the other end of a call. The echo-canceler control parameter, the sound-volume control parameter, the received-voice frequency-band control parameter, and the jitter-buffer control parameter are each an example of “control parameter”. The jitter-buffer control parameter may be recorded in association with combination of identification information of an edge apparatus 20 housing a user terminal of a user terminal ID and identification information of an edge apparatus 20 housing a user terminal 30 on the other end of a call.

A user terminal ID is identification information of a user terminal 30. The user terminal ID may be, for example, a phone number. Alternatively, the user terminal ID may be, for example, identification information of a port of an edge apparatus 20 to which a cable from the user terminal 30 is connected.

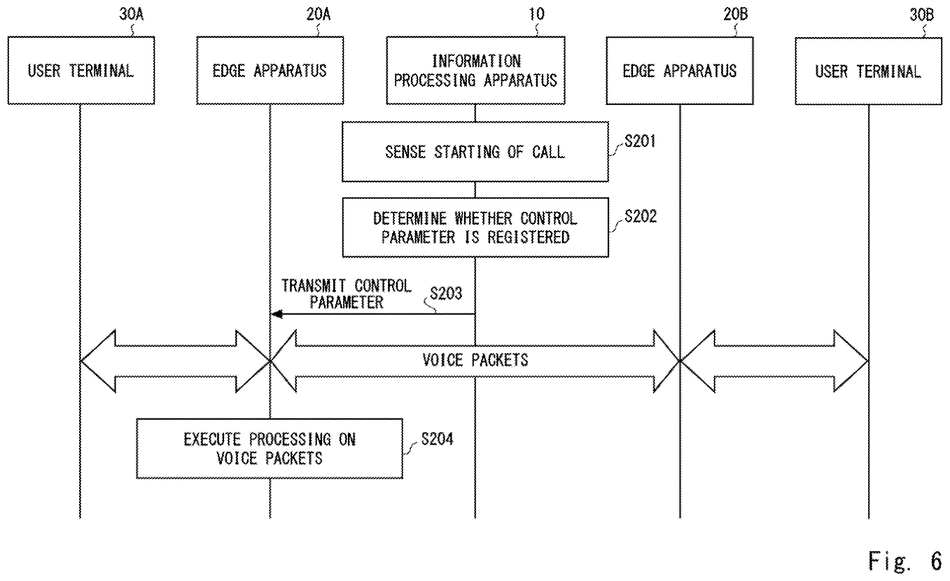

Processing in a case where no control parameters for the user terminal 30A is recorded in the control parameter DB 501 (for example, a case of first-time calling) in the processing at step S102 will be described next. Processing when control parameters for the user terminal 30A are recorded in the control parameter DB 501 (for example, in a case of the second-time calling or later) will be described later with reference to FIG. 6.

Subsequently, the transmission unit 12 of the information processing apparatus 10 transmits a particular command to the edge apparatus 20A (step S103). The command may include ID of a call session.

Subsequently, having received the command, the edge apparatus 20A specifies a control parameter related to call quality when a call is made between the user terminal 30A and the user terminal 30B (step S104). Subsequently, the edge apparatus 20A executes particular processing on voice packets of the call based on the specified control parameter (step S105).

Examples of the processing by the edge apparatus 20A at steps S104 and S105 will be described below. The edge apparatus 20A may combine the examples below as appropriate for execution.

Example in which Echo is Reduced

The echo-canceler control parameter may include information used in processing of reducing echo due to the line between the user terminal 30A and the edge apparatus 20A. For example, a two-wire/four-wire conversion circuit (hybrid circuit) is included in the communication line A between the user terminal 30A and the edge apparatus 20A, and the hybrid circuit has an impedance mismatch. In this case, part of a signal from a four-wire transmission path to the receiving side of the hybrid circuit sneaks to the four-wire transmission path on the transmitting side of the hybrid circuit through the hybrid circuit, and accordingly, an echo path is formed. Echo generation is determined by the level of a signal passing through the echo path and a transfer characteristic on the four-wire transmission path side. Whether echo is sensed is determined in correlation with two parameters, namely, a round transmission loss of the line taken for returning to the receiving side from the transmitting side at the signal source and including a sneak loss (return loss) in the hybrid circuit and a round transmission delay time taken for a signal to return to the receiving side from the transmitting side at the signal source. In this manner, echo occurs when the round transmission delay time of a signal path is long or when the round transmission loss is small, which leads to degradation of the call quality.

In this case, for example, the edge apparatus 20A may remove an echo component by presuming a transfer characteristic of the echo path, generating a pseudo echo signal, and subtracting the pseudo echo signal from a signal sneaking through the hybrid circuit. In this case, the echo-canceler control parameter may include information indicating the presumed transfer characteristic of the echo path.

Example in which Jitter Buffer Amount is Determined

The jitter-buffer control parameter may include information indicating a setting value of a jitter buffer for packets of call voice received by the user terminal 30A through the edge apparatus 20A. In this case, for example, the edge apparatus 20A may determine a jitter buffer amount based on packets of call voice in a real-time transport protocol (RTP) received from the edge apparatus 20B. Then, the edge apparatus 20A may adjust delay of the received RTP based on the determined jitter buffer amount. Accordingly, for example, discontinuity of voice played back at the user terminal 30A can be reduced. In this case, the jitter-buffer control parameter may include information indicating the determined jitter buffer amount.

Example in which Receiver Volume is Adjusted

The sound-volume control parameter may include information indicating a setting value of receiver volume (volume level) in accordance with a user of the user terminal 30A. In this case, for example, the edge apparatus 20A may estimate an attribute (for example, age) of the user of the user terminal 30A by using artificial intelligence (AI) based on speech voice of the user. Then, for example, the edge apparatus 20A may adjust (increase and decrease) the volume of voice from the user terminal 30B in accordance with the estimated attribute and then transmit the voice to the user terminal 30A. Accordingly, for example, the volume level can be changed to volume that is easy to hear by the user of the user terminal 30A who is an aged person or the like without an operation to change the volume level on the user terminal 30A.

Example in which Frequency Band of Received Voice is Adjusted

The received-voice frequency-band control parameter may include information indicating a setting value of the frequency band of transmitted voice in accordance with a user on the other end of a call. In this case, for example, the edge apparatus 20A may estimate an attribute (for example, age) of a user of the user terminal 30B by using AI based on speech voice of the user received from the edge apparatus 20B. Then, for example, the edge apparatus 20A may determine the frequency band of voice encoding at the user terminal 30A in accordance with the estimated attribute. Accordingly, for example, when the user of the user terminal 30B is an aged person or the like, a relatively high frequency that is hard to hear by the aged person can be cut in encoding. Thus, a used network band can be reduced. In this case, for example, the edge apparatus 20A may determine the scheme of voice encoding at the user terminal 30A in accordance with the estimated attribute.

Subsequently, the edge apparatus 20A transmits the specified control parameter to the information processing apparatus 10 (step S106). Subsequently, the management unit 11 of the information processing apparatus 10 records (registers) the received control parameter in the control parameter DB 501 (step S107).

### Processing of Using Control Parameter

An example of processing of using a control parameter in the call system 1 according to the example embodiment will be described next with reference to FIG. 6. FIG. 6 is a sequence diagram illustrating the example of processing of using a control parameter in the call system 1 according to the example embodiment.

The following description will be made with an example in which processing related to call quality is performed by the edge apparatus 20A when a call is made between the user terminal 30A and the user terminal 30B. The description is the same irrespective of whether a call request (outgoing call) is made by the user terminal 30A or the user terminal 30B, but the description will be made with a case where call request is made by the user terminal 30A. In a case where a call request is made by the user terminal 30B and received by the user terminal 30A, for example, call request and outgoing in the following description may be interpreted as call reception and incoming, respectively.

At step S201, the management unit 11 of the information processing apparatus 10 senses starting of a call between the user terminal 30A and the user terminal 30B. Subsequently, the management unit 11 of the information processing apparatus 10 determines whether any control parameter for the user terminal 30A is recorded (registered) in the control parameter DB 501 (step S202). The processing at steps S201 and S202 may be the same as the processing at steps S101 and S102 in FIG. 4. Processing in a case where any control parameter for the user terminal 30A is recorded in the control parameter DB 501 in the processing at step S202 will be described below.

Subsequently, the transmission unit 12 of the information processing apparatus 10 transmits the control parameter for the user terminal 30A, which is recorded in the control parameter DB 501, to the edge apparatus 20A (step S203). Accordingly, for example, in a case of the second-time calling or later, echo reduction, jitter buffer setting, receiver volume adjustment, received-voice frequency-band adjustment, and the like can be executed by the edge apparatus 20A at a timing earlier than in a case of the first-time calling.

Subsequently, the edge apparatus 20A executes particular processing on voice packets of the call based on the received control parameter (step S204). The processing at step S204 may be the same as the processing at step S105 in FIG. 4. Accordingly, for example, the load and electric power consumption of processing of specifying the control parameter by the edge apparatus 20A can be reduced in a case other than the first-time calling or the like. The processing at step S204 may be executed when transmission-reception of voice packets of the current call is started. In this case, for example, the edge apparatus 20A may start at least part of the processing at step S204 after a call session (call control session) is established and before a voice packet path is established.

Example in which Control Parameter is Updated

The information processing apparatus 10 may cause the edge apparatus 20A to specify a control parameter again when the environment of a call between the user terminal 30A and the user terminal 30B has changed. In this case, the management unit 11 of the information processing apparatus 10 may sense that the network environment of the call between the user terminal 30A and the user terminal 30B has changed based on the contents of RTP control protocol (RTCP) packets in the call. The management unit 11 of the information processing apparatus 10 may determine that the network environment of the call has changed when an edge apparatus 20 housing a cell (base station) in which the user terminal 30A that is a mobile terminal is staying has changed. When the network environment of the call has changed, the management unit 11 of the information processing apparatus 10 may execute the processing at step S103 and later in FIG. 4 again.

### Modification

The information processing apparatus 10 may be an apparatus included in one housing but the information processing apparatus 10 of the present disclosure is not limited thereto. Each component of the information processing apparatus 10 may be implemented by, for example, cloud computing constituted by one or more computers. The information processing apparatus 10 and an edge apparatus 20 may be housed in the same housing and configured as an integrated information processing apparatus. At least part of processing at each functional component of the information processing apparatus 10 may be executed by at least one of an edge apparatus 20 and a user terminal 30. The information processing apparatus 10 having these configurations is included in examples of an “information processing apparatus” of the present disclosure.

Each of the above-described embodiments can be combined as desirable by one of ordinary skill in the art.

An example advantage according to the above-described embodiments is reduction of a processing load at calling.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

Part or all of the above-described example embodiments can be written as in the following supplementary notes but is not limited thereto.

### Supplementary Note 1

An information processing apparatus including:
a management unit configured to manage a control parameter related to call quality of a call previously made with a user terminal; and
a transmission unit configured to relay packets of call voice and transmit the packets to an edge apparatus when a call is made with the user terminal, the edge apparatus being configured to perform processing based on the control parameter.

### Supplementary Note 2

The information processing apparatus according to Supplementary note 1, in which in a case where the control parameter is not managed when a call is made with the user terminal, the management unit transmits a particular command to the edge apparatus, and receives, from the edge apparatus, a control parameter related to call quality when the call is made, to manage the received control parameter.

### Supplementary Note 3

The information processing apparatus according to Supplementary note 1 or 2, in which the control parameter includes information used in processing of reducing echo due to a line between the user terminal and the edge apparatus.

### Supplementary Note 4

The information processing apparatus according to any one of Supplementary notes 1 to 3, in which the control parameter includes information indicating a setting value of a jitter buffer for packets of call voice received by the user terminal through the edge apparatus.

### Supplementary Note 5

The information processing apparatus according to any one of Supplementary notes 1 to 4, in which the control parameter includes information indicating a setting value of receiver volume in accordance with a user of the user terminal.

### Supplementary Note 6

The information processing apparatus according to any one of Supplementary notes 1 to 5, in which the control parameter includes information indicating a setting value of a frequency band of transmitted voice in accordance with a user on the other end of a call.

### Supplementary Note 7

An information processing method including:
managing a control parameter related to call quality of a call previously made with a user terminal; and
   relaying packets of call voice and transmitting the packets to an edge apparatus when a call is made with the user terminal, the edge apparatus being configured to perform processing based on the control parameter.

### Supplementary Note 8

A program configured to cause a computer to execute processing including:
managing a control parameter related to call quality of a call previously made with a user terminal; and
relaying packets of call voice and transmitting the packets to an edge apparatus when a call is made with the user terminal, the edge apparatus being configured to perform processing based on the control parameter.

### Supplementary Note 9

A call system including an information processing apparatus and an edge apparatus, in which
the information processing apparatus includes
   a management unit configured to receive, from the edge apparatus, a control parameter related to call quality of a call previously made with a user terminal and manage the received control parameter, and
   a transmission unit configured to relay packets of call voice and transmit the packets to the edge apparatus when a call is made with the user terminal, the edge apparatus being configured to perform processing based on the control parameter, and
the edge apparatus performs processing on voice packets of a call with the user terminal based on the control parameter received from the information processing apparatus.

### Supplementary Note 10

The call system according to Supplementary note 9, in which in a case where the control parameter is not managed when a call is made with the user terminal, the management unit transmits a particular command to the edge apparatus, and receives, from the edge apparatus, a control parameter related to call quality when the call is made, to manage the received control parameter.

### REFERENCE SIGNS LIST

1 CALL SYSTEM
10 INFORMATION PROCESSING APPARATUS
11 MANAGEMENT UNIT
12 TRANSMISSION UNIT
20 EDGE APPARATUS
30 USER TERMINAL

What is claimed is:

1. An information processing apparatus comprising:
a management unit configured to manage a control parameter related to call quality of a call previously made with a user terminal; and
a transmission unit configured to relay packets of call voice and transmit the packets to an edge apparatus when a call is made with the user terminal, the edge apparatus being configured to perform processing based on the control parameter.

2. The information processing apparatus according to claim 1, wherein in a case where the control parameter is not managed when a call is made with the user terminal, the management unit transmits a particular command to the edge apparatus, and receives, from the edge apparatus, a control parameter related to call quality when the call is made, to manage the control parameter.

3. The information processing apparatus according to claim 1, wherein the control parameter includes information used in processing of reducing echo due to a line between the user terminal and the edge apparatus.

4. The information processing apparatus according to claim 1, wherein the control parameter includes information indicating a setting value of a jitter buffer for packets of call voice received by the user terminal through the edge apparatus.

5. The information processing apparatus according to claim 1, wherein the control parameter includes information indicating a setting value of receiver volume in accordance with a user of the user terminal.

6. The information processing apparatus according to claim 1, wherein the control parameter includes information indicating a setting value of a frequency band of transmitted voice in accordance with a user on the other end of a call.

7. An information processing method comprising:
managing a control parameter related to call quality of a call previously made with a user terminal; and
relaying packets of call voice and transmitting the packets to an edge apparatus when a call is made with the user terminal, the edge apparatus being configured to perform processing based on the control parameter.

8. A non-transitory computer-readable medium storing a program configured to cause a computer to execute processing comprising:
managing a control parameter related to call quality of a call previously made with a user terminal; and
relaying packets of call voice and transmitting the packets to an edge apparatus when a call is made with the user terminal, the edge apparatus being configured to perform processing based on the control parameter.
